(19) United States
(12) Patent Application Publication
(10) Pub. No.: US 2008/0126095 A1
(43) Pub. Date: May 29, 2008

(54) System and method for adding functionality to a user interface playback environment

(76) Inventor: Gil Sideman, Tenafly, NJ (US)

Correspondence Address: Pearl Cohen Zedek Latzer, LLP, 1500 Broadway, 12th Floor, New York, NY, 10036, US

(21) Appl. No.: 11/976,733

(22) Filed: Oct. 26, 2007

Related U.S. Application Data
(60) Provisional application No. 60/854,681, filed on Oct. 27, 2006.

(51) Int. Cl. G10L 21/06; G10L 21/00

(52) U.S. Cl. 704/260; 704/270.1; 704/E21.017; 704/E15.019

(57) ABSTRACT

A method and system may provide an interface (e.g., “API”), client side software module or other process that may accept client input defining a playback environment, such as a speech output interface, accept client input selecting preprogrammed functionality for operating the speech playback environment, accept client input tailoring the preprogrammed functionality based on the client input, create the speech playback environment, and create embedded code to embed the speech playback environment within a website for providing speech output. A method and system may provide a website including web-site code controlling the operation of the website and plug-in code providing preprogrammed functionality for operating an embedded speech playback environment, where the plug-in code is tailored by a client, where the web-site code is to query the plug-in code for speech requests and requests for preprogrammed functionality in addition to speech functionality.

### RELATED APPLICATION DATA

The present application claims benefit from prior provisional application Ser. No. 60/854,681, filed on Oct. 27, 2006, entitled, “System and Method For Adding Functionality to a User Interface Playback Environment”, incorporated by reference herein in its entirety.

### BACKGROUND OF THE INVENTION

Computing or software systems exist that provide an embedded playback environment including a speech output. The playback environment may be embedded in an environment, such as a website, and speech data may be provided locally or by a separate source, such as a remote server. The playback environment may be displayed locally, for example, as a graphical user interface, and may include for example, audio output, video output, and/or other media output. Some systems may combine audio and video outputs to provide audible speech with animated figures that may seem to produce the speech. For example, a text to speech “engine” may take as input a string, and may cause an animated figure to say the text contained in the string, possibly in a selected language.

In such a configuration, the interface between a client program, such as for example a website or a web browser, or software integrated into a website or web browser, and an embedded playback environment may be complex and difficult to use. Further, it may be difficult to provide speech output customized to an individual user's needs.

### SUMMARY

A method and system may provide an interface (e.g., “API”), client side software module or other process that may accept client input defining a playback environment, such as a speech output interface, accept client input selecting preprogrammed functionality for operating the speech playback environment, accept client input tailoring the preprogrammed functionality based on the client input, create the speech playback environment, and create embedded code to embed the speech playback environment within a website for providing speech output. A method and system may provide a website including web-site code controlling the operation of the website and plug-in code providing preprogrammed functionality for operating an embedded speech playback environment, where the plug-in code is tailored by a client, where the web-site code is to query the plug-in code for speech requests and requests for preprogrammed functionality in addition to speech functionality.

### BRIEF DESCRIPTION OF THE DRAWINGS

The present invention will be understood and appreciated more fully from the following detailed description taken in conjunction with the drawings in which:

FIG. 1 depicts a local and remote system, according to one embodiment of the present invention;

FIG. 2 depicts a web page produced by an embodiment of the present invention, and its interaction with various components of one embodiment of the present invention;

FIG. 3 depicts a client interface for creating or designing additional functionality for a playback environment that is to be embedded into for example a web page, according to an embodiment of the present invention, and its interaction with various components of one embodiment of the present invention;

FIG. 4 is a flowchart describing a method according to one embodiment of the present invention;

FIG. 5 is a flowchart describing a method according to one embodiment of the present invention; and

FIG. 6 is user interface for allowing a client to create an embedded playback environment with additional functionality, according to one embodiment of the invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

The processes presented herein are not inherently related to any particular computer or other apparatus. Various general-purpose systems may be used with programs in accordance with the teachings herein, or it may prove convenient to construct a more specialized apparatus to perform embodiments of a method according to embodiments of the present invention. Embodiments of a structure for a variety of these systems appears from the description herein. In addition, embodiments of the present invention are not described with reference to any particular programming language. It will be appreciated that a variety of programming languages may be used to implement the teachings of the invention as described herein.

Unless specifically stated otherwise, as apparent from the discussions herein, it is appreciated that throughout the specification discussions utilizing data processing or manipulation terms such as “processing”, “computing”, “calculating”, “determining”, or the like, typically refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

When used herein “client” may mean an entity such as a person or organization that creates or tailors speech output functionality possibly including augmented functionality, typically to be combined or used with a client-created or client-operated web page. A client may be distinguished from a user, which when used herein typically refers to the person using or operating a web site created by a client using for example a process described herein. “Client” may also, when referring to a computer process such as a software module, be used as is known in the art, and may in this context mean a computer process using the services of another process such as a remote server or a local process. However, note that any person or entity, whether a called a “client” or “user” may access the design capabilities or the resulting web software or text-to-speech or speech output software in accordance with embodiments of the present invention. For example, the same person, who is not a client of a provider, may create an embedded playback environment with enhanced functionality using software provided by that provider, and in addition may use the code created by the software.

One embodiment of the present invention may provide an embedded playback environment including a speech output interface, which may be customized to an individual user's needs. For example, the embedded playback environment may include additional preprogrammed functionality that enables the speech embedded playback environment to interact with the user, for example, to provide speech output based on user input. Speech output may be provided locally or by a separate source, such as a remote server. In some embodiments, a client, for example, may tailor the additional functionality.

In one embodiment, a method or system may define a speech playback module, the module including code to accept speech requests from a user module and producing speech output, define further code which when executed provides second preprogrammed functionality separate from and augmenting the speech playback module, the second functionality not including speech functionality, the second functionality including functionality interacting with both a user and the speech playback module, and create an embedded code module including the first code and the second code.

In one embodiment, a method or device may include separate sets of code executed by a processor. A first set of code may operating a speech output module accepting speech requests and outputting speech audible to a user. A second set of code may be a associated with the first set of code and may operate non-speech functionality. A third set of code (e.g., a website) may be separate from the first set of code and from the second set of code and may operate a web-site. The third set of code may generating a speech request and send the speech request to the first set of code, and may generate a request for non-speech functionality and send the speech request to the third set of code.

One embodiment of the present invention includes a client-server implementation, where text-to-speech generation takes place on the server side, and playback takes place on the client side.

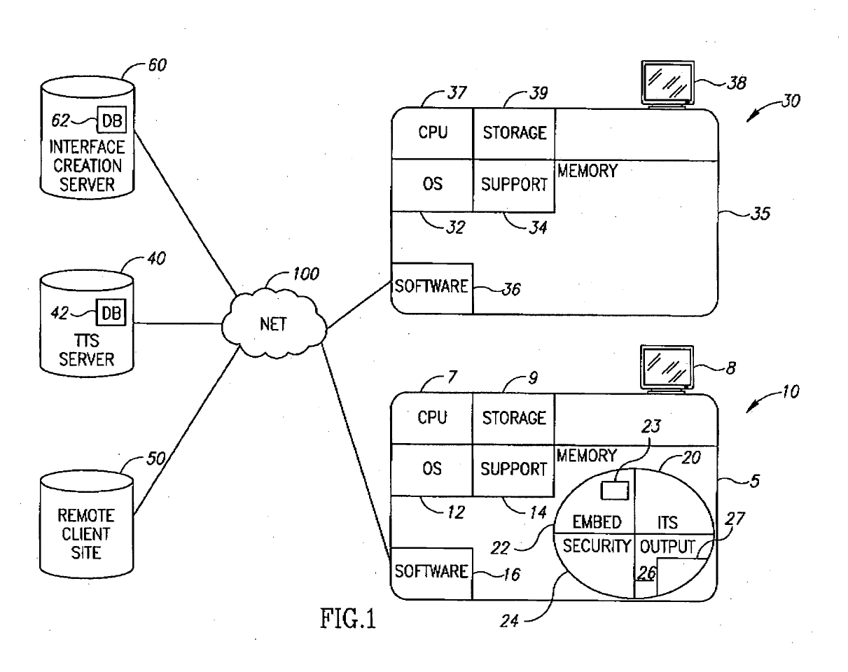

Embodiments of the present invention may provide or allow for the creation of an embedded playback environment including additional client designed functionality. Additional functionality may include for example, “FAQ” functionality, “artificial intelligence” (AI) functionality, “lead generation” functionality, described below in reference to FIG. 1, or any other suitable functionality. The additional functionality may be implemented using preprogrammed output packages contained within the embedded playback environment. The client may input information into a design interface provided, for example, by a possibly remote interface creation server, to tailor or customize the additional functionality of the embedded playback environment.

In one embodiment, a set of code operating a web-site may generate requests that may be sent to a speech output module. The speech output module may, for example, reside within the web-site code but be separate from the web-site code, but may be placed in other locations. Speech output may, for example, be stored locally, at a client or within a speech output module, may be generated remotely, for example via a text-to-speech server, or may be stored or generated differently. The speech output module may include code separate from set of code operating the web-site. The website code may further generate requests for non-speech functionality, which may be sent to and fulfilled by the speech output module. For example, the speech output module may service, with code separate from the web-site code, requests for FAQ functionality, AI functionality, or other additional functionality that is beyond the scope of speech output functionality, but which may involve or use as an output speech functionality. The web-site code may interface with a remote server (for example a server providing a web-site) which may be separate from a remote text-to-speech server.

Embodiments of the present invention relate to the generation and presentation of speech output, such as in conjunction with speaking animated characters or figures using speech-driven facial animation, which may be integrated into, and utilized in, display contexts, such as wireless and internet-based devices, interactive TV, web sites and applications. Embodiments of the invention may allow for easy installation and integration of such tools in graphic output environments such as web pages.

In one embodiment of the present invention, a method or system may use for example a client process such as a side proxy object with a (typically well defined) client side interface to facilitate audio or speech playback with enhanced functionality. Other or different results or benefits may be achieved.

In one embodiment, a local client process, such as a local set of JavaScript code being executed by a Web browser or other suitable local interpreter or software, interfaces with (for example in a two-way manner) an embedded playback environment (for example providing speech output) possibly via host software such as a local output interface. Typically, the playback environment is or becomes part of, or is integrated into, the local client, accepts output commands or requests from the local client, and provides speech output. The embedded playback environment may operate the local speech output; for example, the local interface may display an animated figure or head within a window within the website operated by the local client, the animated head outputting the speech. The local interface may provide feedback or information to the local client, such as a status of the progress of speech output within a speech unit, a ready/not ready status, or other outputs. If a remote site is used for text-to-speech services, the remote site may authenticate the local client.

A speech output module, such as the animated character, may interact with the web-page user, in that the user's actions on the web page may cause certain output. This is typically accomplished by the local client process software, which is operating the web page, interacting with the output module via the local interface.

Embodiments of the present invention may, for example, allow for an easy, simple and/or secure interface between client code (e.g., code operating on a personal computer producing or operating a website and speech output code (which in turn may provide speech functionality for the website). Other or different benefits may result from embodiments of the present invention.

FIG. 1 depicts a local and remote system, according to one embodiment of the present invention. Local computer 10 may include a memory 5, processor 7, monitor or output device 8, and mass storage device 9. Local computer 10 may include an operating system 12 and supporting software 14 (e.g., a web browser or other suitable local interpreter or software), and may operate a local client process or software 16 (e.g., JavaScript or other suitable code operated by the supporting software 14) to produce an interactive display such as a web page. Local computer 30 may include a memory 35, processor 37, monitor or output device 38, and mass storage device 39. Local computer 30 may include an operating system 32 and supporting software 34 (e.g., a design interface, a web browser for communicating with a remote interface creation server providing a design interface or other suitable local interpreter or software), and may operate a local client process or software 36 (e.g., JavaScript or other suitable code operated by the supporting software 14) to produce an interactive display such as a design interface.

In one embodiment, local computer 30 is used by a client to create a plug-in for a website, where the website is to be used (e.g., as client software 16, code 20, and other code modules) on user computer 10. Thus local computer 30 and client computer 10 may be used at different times and may not be connected to the same network or servers; the arrangement of components in FIG. 1 is one example only.

Local computer 10 may include embed code 22, user-adapted preprogrammed functionality code 23, an interface module such as a speech output code 20, possible security and utility code 24, and output module 26. Speech output code 20 may provide speech output to be displayed via an embedded playback environment. Embed code 22 may include or be associated with user-adapted preprogrammed functionality code 23, which may be for example created by a user, and which may provide additional functionality to embed code 22. Such functionality may be created by a user in conjunction with an automated process, possibly operated by a remote server. Such addition functionality may be for example, AI functionality, FAQ functionality, etc. While code and software is depicted as being stored in memory 5, such code and software may be stored or reside elsewhere. Embed code 22 may be, for example, several lines of text inserted or embedded into client's web page source code (e.g., client process or software 16) which may, for example, load other code into the source code. For example, when client process or software 16 is initiated or started, embed code 22 may “bootstrap” the overall speech output code 20 sections of the web page code and if needed may download security and utility code 24 from, for example, a remote text-to-speech server 40 or another source, and associate the security and utility code 24, with client software 16, or embed this code within client software 16. The uploading or bootstrapping may involve different sets of codes, written in different languages, and thus having different capabilities. The embed code 22 may write code, for example HTML code, into client software 16, to enable client software 16 to communicate with speech output code 20. Local client 16 and speech output code 20 may reside on the same system, such as local computer 10. After loading, embed code 22 and speech output code 20, and user-adapted preprogrammed functionality code 23 may be integral to the client process or software 16, but also may be integrated as a separate module within client software 16. Processes within client software 16 may easily make requests to speech output code 20 and user-adapted preprogrammed functionality code 23, and client software 16 may be developed separately from speech output code 20 and user-adapted preprogrammed functionality code 23. Embodiments of the present invention may use embed methods or embed code and possibly text-to-speech requests as described in, for example, application Ser. No. 11/364,229, entitled “System and Method For A Real Time Client Server Text to Speech Interface”, filed on Mar. 1, 2006, incorporated by reference herein in its entirety; other methods may be used.

Optional text-to-speech server 40 may accept text-to-speech request from, e.g., speech output code 20 or security requests from security code 24, and may provide, e.g., text-to-speech output, such as audio files and/or visemes. In some embodiments, such a remote server is not required, for example if speech output is generated or stored locally.

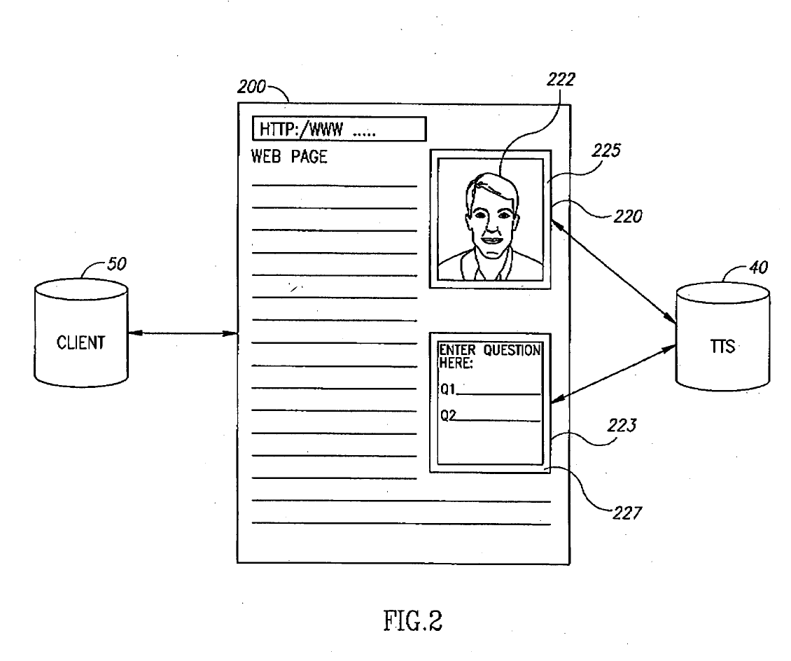

User-adapted preprogrammed functionality code 23 may provide additional functionality to an embedded playback environment by augmenting or working in conjunction with output module 26, which produces the embedded playback environment, for example, embedded playback environment 220 described below with reference to FIG. 2. Additional functionality may include, for example, AI functionality, FAQ functionality, etc. Other additional or augmented functionality may be implemented using embodiments of the present invention.

In one embodiment, the FAQ functionality may include accepting frequently asked questions from a user and providing the associated answers. A client may create such functionality in conjunction with an automated process, for example as described herein. For example, when using a tool to create or tailor output module 26, a client may be offered a set of (one or more) additional functionality packages, including for example a FAQ package. The client may enter for example the questions and associated answers, and the tool or automated process may create, based on pre-programmed code, user-adapted preprogrammed functionality code 23, and may augment output module 26 to include or be associated with this code to provide corresponding client-generated responses via an embedded playback environment. In some embodiments, the responses may include speech content, such as animated speaking figure and speech corresponding to the animated speaking figure, which may be provided locally or by a separate source, such as remote text-to-speech server 40.

AI package functionality may include providing artificial intelligence applications to speech output. For example, AI functionality may accept questions from a user and providing associated answers, or provide other functionality, possibly employing the services of an AI server or AI engine. A client may create such functionality in conjunction with an automated process, as described herein. For example, when using a tool to create or tailor output module 26, a client may be offered a set of (one or more) additional functionality packages, including for example an AI package. The client may enter customized client-specific data, and the tool or automated process may create, based on pre-programmed code, user-adapted preprogrammed functionality code 23, and may augment output module 26 to include provide AI functionality, for example by applying artificial intelligence agents to the user-adapted preprogrammed functionality code 23, as is known, via an embedded playback environment. For example, the client may enter code including customized client-specific data such as a listing of the operation hours of Store, X, being Mon-Fri, 8 am-10 pm. In a client website, AI functionality may accept a question from a user, for example, “What are the hours of operation of store X on Monday”. The AI functionality may cause module 26 to generate a desired speech output response, for example, an animated speaking figure verbalizing the statement, “The hours of operation of store X on Monday are 8 am-10 pm”.

Augmented functionality including lead generation functionality may include for example requesting contact information from users of a client's website and providing the contact information to the client. For example, lead generation functionality may use an additional functionality user interface to query users about contact information and store the information for providing promotional or marketing materials to the user. The lead generation functionality may cause output module 26 to provide the user with a response including a request for additional information, such as “[Client Name] cannot answer your question at this time. Please enter your contact information and a sales representative will contact you as soon as possible.” The client may accept additional information, such as, contact information, from the user entered, for example, into a text box provided by the client web page, where the client may access the additional information. A client may create such functionality in conjunction with an automated process, for example as described herein.

For example, when using a tool to create or tailor output module 26, a client may be offered a set of (one or more) additional functionality packages, including for example lead generation package. The client may enter desired responses or standards for acceptable responses to questions, and the tool or automated process may create, based on pre-programmed code, user-adapted preprogrammed functionality code 23, and may augment output module 26 to include or be associated with this code to determine whether or not the embedded playback environment may provide desired responses, and if the embedded playback environment does not provide desired responses, request for additional information form the user via the embedded playback environment. In some embodiments, the responses may include speech content, such as animated speaking figure and speech corresponding to the animated speaking figure, which may be provided locally or by a separate source, such as a remote server.

Audio information and facial movement commands (e.g., an audio file or stream and automatically generated lip synchronization, facial gesture information, or viseme specifications for lip synchronization) may be provided by output module 26, possibly interfacing with remote text-to-speech server 40, based on preprogrammed client designed functionality; other formats may be used and other information may be included). In one embodiment, output module 26 is merely an interface to access speech output functionality stored on local computer 10 or streamed directly from a remote server, and output module 26 does not include capability for producing speech in response to text, but rather outputs and displays speech in response to output requests received from client software 16. Output module 26 in one embodiment includes information for producing graphics corresponding to lip, facial or other body movements, modules to convert visemes or other information to such movements, etc. Output module 26 may, for example output automatically generated lip synchronization information in conjunction with audio data. A remote client site 50 may provide support, processing, data, downloads or other services to enable local client software 16 to provide a display or services such as a website. For example, if local client software 16 operates a site for marketing a product from a web-based retailer, remote client site 50 may include databases and software for operating the web-based retailer website. Typically remote client site 50 and local computer 10, operate known software (e.g., database software, web server software, speech or media output software, lip synchronization software, body movement software), and are connected via one or more networks such as the Internet 100.

FIG. 2 depicts a web page produced by an embodiment of the present invention, and its interaction with various components of one embodiment of the present invention. Web page 200 (which may, for example, be displayed on monitor 8), may include an embedded playback environment 220, which may be tailored by a client to be adaptable an individual user's needs, for example, to provide speech output based on user input. For example, embedded playback environment 220 may include additional preprogrammed functionality for interacting with the user. Software 16 may include web-site code controlling the operation of web page 200. For example, embedded playback environment 220 may include animated form or FIG. 222. Embedded playback environment 220 may contain or may operate additional functionality user interface 223, operated by preprogrammed functionality code 23. Additional functionality user interface 223 may appear in an area outside embedded playback environment 220, and may appear only when needed. In other embodiments, preprogrammed functionality 23 may, instead of operating an area within embedded playback environment 220, cause embedded playback environment 220 or animated FIG. 222 to operate in a certain manner. For example preprogrammed functionality code 23 may cause animated FIG. 222 to query the user regarding leads, or to interact with the user regarding FAQ questions. User-adapted preprogrammed functionality code 23 need not use additional functionality user interface 223 to operate, but may rather collect input and sent output via web page 200 in general and/or FIG. 222.

In one embodiment embedded playback environment 220 is for example an embed rectangle containing a dynamic speaking figure or character. Other output modules may be displayed by embedded playback environment 220. The code operating web page 200 may interact with remote client site 50 to provide web page 200. The code operating embedded playback environment 220 may interact with output module 26 to provide embedded playback environment 220. Speech output API code 20 and/or embed code 22 may allow web page 200 to interact with embedded playback environment 220.

Speech output API code 20 may, for example, accept requests from local client software 16 and possibly authenticate the client using, for example, security and utility code 24, which may generate security or verification information allowing, for example, remote text-to-speech server 40 to verify that the Web page 200 is authorized to request speech output or other services. In one embodiment, output module 26 is a Flash language component, and security and utility code 24 is a component written in a different language, such as the JavaScript language. Incorporated as a parameter in the output module 26 may be, for example security or verification parameter 27. Security parameter 27 may be, for example, the title or label corresponding to the domain name of Web page 200.

In one embodiment, security or verification information includes both the identity of the client process and a domain name. The pairing of the domain name and the client identity may serve as an authentication key. Security or verification information may correspond to or identify the local client in other manners. Embodiments of the present invention may use security or verification methods or code as described in, for example, application Ser. No. 11/364,229, entitled “System and Method For A Real Time Client Server Text to Speech Interface”, filed on Mar. 1, 2006, incorporated by reference herein in its entirety; other methods may be used.

Other suitable languages or code segments may be used. Other suitable methods of finding identifying information such as the domain may be used, and other identifying information other than the domain may be used.

In some embodiments, Web page 200 may provide additional functionality user interface 223 and/or may provide an interface for accepting user input for operating and interfacing with preprogrammed functionality code 23. User input may include, for example, information requests, FAQ questions, lead information, etc. In some embodiments, additional functionality user interface 223 may include a prompt to request input from the user.

The user-adapted preprogrammed functionality code 23 may augment output module 26 and augment the functionality of embedded playback environment 220 or animated FIG. 222. For example, preprogrammed functionality code 23 may cause embedded playback environment 220 or animated FIG. 222 to operate with the additional functionality, for example described above in reference to FIG. 1. For example, animated FIG. 222 may query the user regarding leads, or interact with the user regarding FAQ questions. In various embodiments, additional functionality user interface 223 may include one or more interfaces, for example, a FAQ interface 224, an AI interface 226, and/or a lead generation interface 228.

A simple procedure call may cause user-adapted preprogrammed functionality code 23 to, for example, operate an AI feature, or cause the animated FIG. 222 to for example, accept FAQ questions and generate FAQ answers.

Output module 26 may include, for example, a set of function calls which allows the animated FIG. 222 or another output area which is embedded in the client web page to connect with the web page. If needed output module 26 may query utility code 24 for security or identification information (e.g., a web address, web page name, domain name, or other information) and pass the request or information in the request, plus the security or identification information, to the text-to-speech server 40, for example via network 100. Text-to-speech server 40 may use security or identification information for verification, metering, or other purposes. Output module 26 may output speech content in embedded playback environment 220 by, for example, having animated FIG. 222 output audio and move according to viseme or other data. Speech content may be provided locally or by a separate source, such as a remote server. Output module 26 may provide information to local client software 16 before, during, or after the speech is output, for example, ready to output, status or progress of output, output completed, busy, etc.

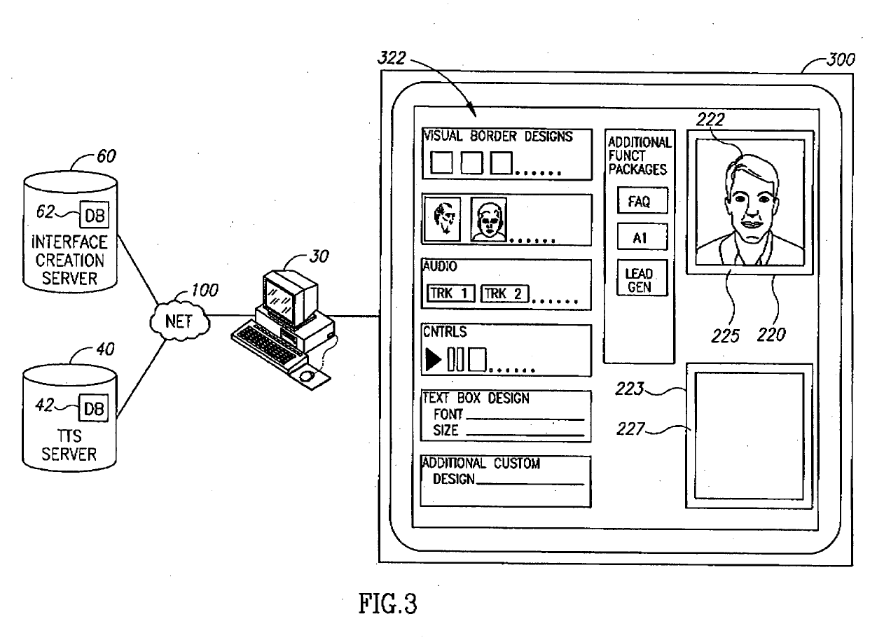

FIG. 3 depicts a client interface for creating or designing additional functionality for an embedded playback environment, for example, embedded playback environment 220, including AI functionality, FAQ functionality, or other functionality that is to be embedded into a web page, according to an embodiment of the present invention, and its interaction with various components of one embodiment of the present invention. In one embodiment, a client may use a design interface 300, displayed on a local computer 30, to design or customize the content, including aesthetic and/or functional properties, of for example embedded playback environment 220, animated FIG. 222, and/or additional functionality user interface 223. Other functionality, differing from that described above, may be designed. For example, a client may enter client generated codes and/or commands or select from among one or more creation options, by inputting information into design input fields 322. In one embodiment, a dynamic design module may change appearance as the client changes design input fields 322. The customer may be presented with tools to upload previously generated designs and/or additional design tools. In one embodiment, the client input is processed remotely: a remote interface creation server 60 may accept client commands from local computer 30 and possibly other sites and produce the content of embed playback environment 220, and create and compile the code resulting from the operations. In another embodiment, a process local to computer 30 accepts the client input to create the code implementing the functionality.

In one embodiment, a client may design, customize, or adapt aesthetic properties of embed playback environment 220. In one embodiment, the client may design aesthetic properties of animated FIG. 222, for example, by selecting from among a plurality of attributes 336, for example, various characters, genders, hair colors, skin tones, ages, lips, lip colors, eyes, clothing outfits, accessories, etc. In one embodiment, the client may select from among a plurality of “voices” or audio files 337 for the audio component of speech output. The client may select from among a plurality of designs for visual borders designs 334 or “skins”, each with a distinct appearance or features such as size, shape, color, border width and/or style, which may be which may be used as visual borders 225 and 227, of embed playback environment 220 and additional functionality user interface 223, respectively. The client may select from among a plurality of controls 338 to be displayed in embed playback environment 220, such as play, pause, stop, etc. Controls 338 may be used by the user to control speech output. Other or different options may be presented to a client.

In one embodiment, the client may design text boxes to be displayed in additional functionality user interface 223, for example, for users to enter information, such as FAQ requests and contact information. The client may design the text boxes for example by selecting text box parameters 340, including, for example, a size for the text boxes and a font and size for text. In some embodiments, an additional custom design field 342 may be provided for the client to further design embed box 220, for example, by creating and/or uploading additional code, displays or design features, for example, streaming banners, audio and/or visual displays, text, images or image streams, music tracks, sound effect tracks, etc.

In one embodiment, the client may design, customize, or adapt the functionality of embed playback environment 220. For example, the client may select from among additional functionality packages 344, such as, AI, FAQ, and/or lead generation packages for integrating AI, FAQ, and/or lead generation functionality, as described above in reference to FIG. 1. Additional functionality packages 344 may include preprogrammed code which may be tailored by clients, and which may be compiled into suitable languages or codes for insertion into or integration with code operating a website, for example as a plug-in. Plug-in code may provide preprogrammed functionality for operating, interfacing or augmenting the speech output interface of embed playback environment 220. Clients may enter input into design interface 300 to tailor or customize plug-in code and the functionality of speech functionality. For example, the client may enter a data set including questions and answers for the FAQ package.

In one embodiment, interface creation server 60 may include software 36 for operating design interface 300. Software 36 may convert client input and pre-programmed code into client generated code. For example, software 36 may include code for providing additional functionality, such as AI functionality. This code, in conjunction with client input, may be compiled or otherwise converted into final code for provided pre-programmed functionality (possibly with a choice of target languages), such as for example adapted preprogrammed functionality code 23. Client input may include input for defining a speech output interface, for example, in embed playback environment 220, selecting additional functionality packages 344 for operating the embed playback environment 220, and tailoring the preprogrammed functionality of additional functionality packages 344, for example, including a client generated FAQ data set. Client generated code may be stored, for example, in database 62 of interface creation server 60 or in memory 35 or computer 30. Client generated code may be integrated by the client into a client web site.

Client input may include information for operating adapted preprogrammed functionality. For example, if adapted preprogrammed functionality is FAQ functionality, client input may include a set of questions and corresponding answers. When used by a user, an animated figure may speak the answers when a user selects a question displayed on a web site.

Providing a client with preprogrammed functionality which a client can adapt may reduce the burden of creating a website with speech output capability. For example, using current systems, a client may have to create software which provides a FAQ, AI, lead collection, or other capability, create an interface between this capability and a speech output capability, integrate this code into a client web-site, and maintain and improve the code if and when needed. Using embodiments of the present invention, a client may use software such as software 36, provided, updated and maintained by a third party. Software 36 may, in response to client input, create a modular set of code including the tailored preprogrammed functionality and speech functionality (for example, as part of embed code 22, or other suitable code) that can be integrated with or plugged into a client website. The client's programming burden includes only tailoring the code using software 36 and using a simple interface or API to cause the website to operate the speech output and other functionality.

Software 36 may generate client generated code based on client input into design interface 300. Software 36 may use the client generated code to generate a client-designed speech output interface of embed playback environment 220. Software 36 may embed the client generated code into preprogrammed plug-in code, for example, to generate embed code 22. Embed code 22 may operate embed playback environment 220 and client software 16 may operate a client website. According to embodiments of the present invention, embed code 22 and adapted preprogrammed functionality code 23 may be integrated into client software 16 for integrating embed playback environment 220 into the client website. Client software 16 for operating web page 200 may query the plug-in code for speech output requests and requests for preprogrammed functionality in addition to speech functionality. For example, client software 16 may, using a simple command or request, cause adapted preprogrammed functionality code 23 to offer FAQ or other functionality to a user using web site 200.

In some embodiments, embed playback environment 220, provided by output module 26, and the rest of the client website, provided by remote client site 50, may be displayed as a unified graphical user interface. If a text-to-speech process, such as text-to-speech server 40, is used, code 20 may enable a client to interact directly with a local interface, rather than with such a process. Adapted preprogrammed functionality code 23 may provide an encapsulated set of code, separate from a client's own web code (e.g., in client software 16), which may operate additional preprogrammed functionality. A client may be responsible for creating and maintaining client code 16, and a third party may (using an automated process such as software 36) create adapted preprogrammed functionality code 23. Speech output API code 20, adapted preprogrammed functionality code 23, and their components may be implemented in for example JavaScript, ActionScript (e.g., Flash scripting language) and or C++; however, other languages may be used. A client may, after tailoring such functionality, be offered a choice (e.g., by software 36) of in which language the plug-in should be implemented. In one embodiment, embed code 22 is implemented in HTML and JavaScript, generated by server side PHP code, and security and utility code 24 is implemented in for example JavaScript and ActionScript, and output module 26 is implemented in Flash.

One benefit of an embodiment of the present invention may be to reduce the complexity of the programming task or the task of creating a web page that uses separate speech output modules with additional functionality. The programmer or user wishing to integrate a text-to-speech output or a text-to-speech engine with client software such as a web page created by the programmer needs to interface only with a single local entity. Other or different benefits may be realized from embodiments of the present invention.

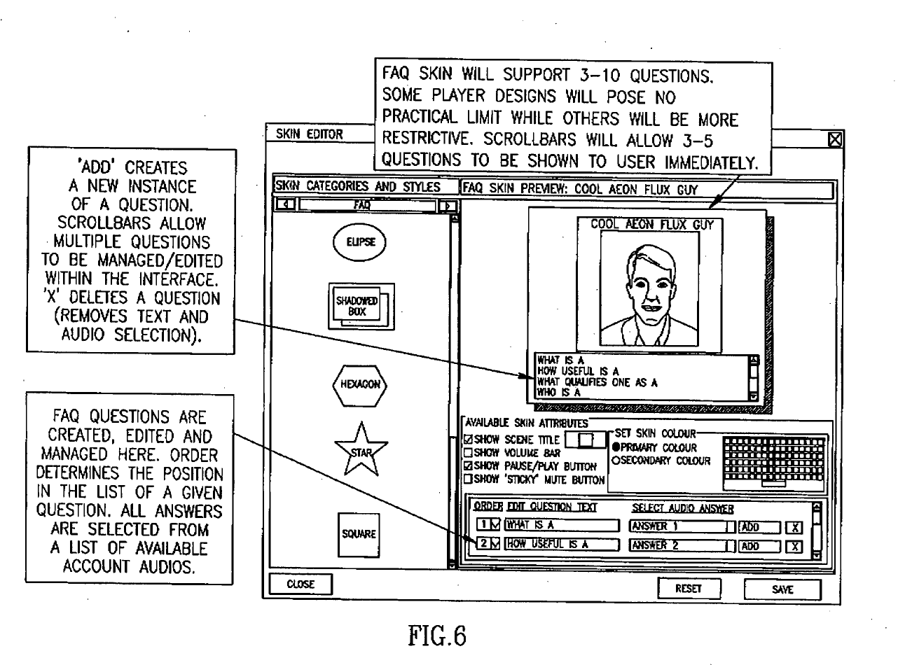

FIG. 6 is a user interface for allowing a client to create an embedded playback environment with additional functionality, according to one embodiment of the invention. Other interfaces may be used.

In one embodiment, additional functionality is integrated into the “skin” of an playback environment displayed to a user in an embedded rectangle in a website. A “skin” or “application skin” may alter the look and/or functionality of a standard embedded playback environment. A skin may include functionality in addition to that described herein. For example, advertisements or other messages may be integrated into the visual display of an embedded playback environment via a skin including such functionality.

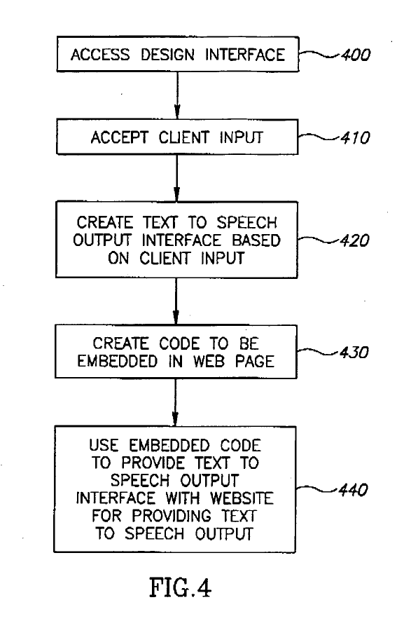

FIG. 4 is a flowchart describing a method according to one embodiment of the present invention.

In operation 400, a person or entity such as for example a client may access a design interface, for example, design interface 300, on a local computer, for example, computer 30, to design or customize the content, including aesthetic and/or functional properties, of an embedded playback environment.

In operation 410, the design interface may accept client input. The design interface may use the client input for defining the embedded playback environment, selecting additional functionality packages for operating the embedded playback environment, and tailoring the preprogrammed functionality of the additional functionality packages. The design interface may also use the client input for defining aesthetic properties of the embedded playback environment.

In operation 420, the design interface may create the embedded playback environment with additional functionality, tailored based on the client input.

In operation 430, the design interface may create code to be embedded in a web page, based on the client input. Embedded code may include code generated from client input in operation 410. Embedded code may include preprogrammed plug-in code tailored based on client input, for operating additional functionality for the embedded playback environment.

In operation 440, the embedded code may provide the playback environment embedded within a website for providing speech output. The embedded code may be integrated into software on a local computer for integrating the playback environment into a website. In some embodiments, the embedded playback environment and the website may appear to be a unified graphical interface, though they may be provided by separate computers, servers or computing systems.

Other operations or series of operations may be used.

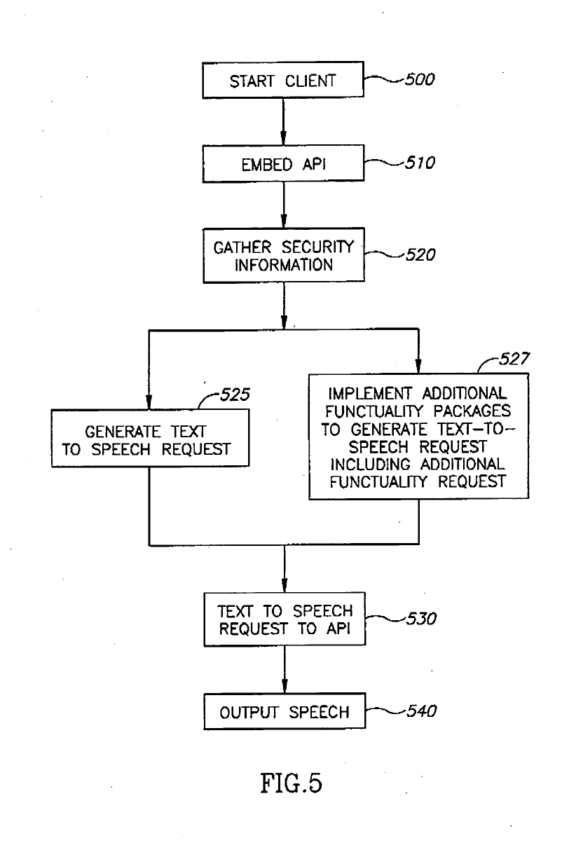

FIG. 5 is a flowchart of a method according to one embodiment of the present invention.

In operation 500, a local client is initiated, started or is loaded onto a local system. For example, a web page is loaded onto a local system.

In operation 510, a part of the local client embeds a playback environment into the local client. In alternate embodiments, such insertion or “bootstrapping” need not be used, and a playback environment may be included in the local client initially. The playback environment may include preprogrammed functionality code.

In operation 520, security information related to the local client may be gathered, for example by an output module or the code loading the output module.

In operation 525 the local client may generate speech output requests exclusively by the local client.

In operation 527 the local client, in conjunction with an additional functionality user interface or with additional functionality embedded within the embedded playback environment or local output module, for example pre-programmed functionality tailored by a user and embedded into the local client along with an embedded playback environment, may generate speech output requests exclusively by the local client. For example, the local client may cause additional functionality code to operate FAQ capabilities, the output of which may be speech; speech output requests may thus be generated to create this output.

In operation 530 the local client may send a speech output request to the local output module. For example, the local client may send the response to a FAQ or other additional capability request created in operation 527. The speech output request may include speech (e.g., audio and possibly viseme data), and may be produced by the local client, or it may be a request to convert text to speech, which may be done locally or, for example, by a remote server.

In operation 540 the output module may provide the user with the speech output via the local embedded playback environment.

Other operations or series of operations may be used. For example, the security features, or other features, need not be used.

It will be appreciated by persons skilled in the art that the present invention is not limited to what has been particularly shown and described hereinabove. Rather the scope of the present invention is defined only by the claims, which follow:

1. A method comprising:
accepting client input defining a speech playback environment;
accepting client input selecting preprogrammed functionality for operating the speech playback environment;
accepting client input tailoring the preprogrammed functionality;
based on the client input, creating the speech playback environment; and
creating embedded code to embed the speech playback environment within a website for providing speech output.

2. The method of claim 1, wherein providing speech output comprises providing an animated speaking figure and speech corresponding to the animated speaking figure.

3. The method of claim 1, wherein providing speech output comprises providing automatically generated lip synchronization information.

4. The method of claim 1, wherein the embedded code comprises preprogrammed plug-in code modified based on the client input.

5. The method of claim 4, wherein the preprogrammed plug-in code provides preprogrammed functionality for operating the embedded speech playback environment.

6. The method of claim 4, wherein the preprogrammed functionality is selected based on the client input.

7. The method of claim 1, wherein the preprogrammed functionality provides a request for contact information.

8. The method of claim 1, wherein the preprogrammed functionality provides responses generated using artificial agents.

9. The method of claim 1, comprising embedding the embedded code in a website.

10. A website, comprising:
web-site code controlling the operation of the website; and
plug-in code providing preprogrammed functionality for operating an embedded speech playback environment, wherein the plug-in code is tailored by a client; wherein the web-site code is to query the plug-in code for speech requests and requests for preprogrammed functionality in addition to speech functionality.

11. The website of claim 10, wherein speech functionality comprises an animated speaking figure and speech corresponding to the animated speaking figure.

12. The website of claim 10, wherein the speech requests are generated based on input accepted from a user.

13. The website of claim 13, wherein providing speech functionality comprises providing a response generated using the plug-in.

14. The website of claim 10, wherein plug-in code tailored by a client is generated based on client input.

15. The website of claim 10, wherein client input comprises selecting the preprogrammed functionality for operating the embedded speech playback environment.

16. The website of claim 10, wherein the preprogrammed functionality comprises providing a response to a frequently asked question.

17. The website of claim 10, wherein the preprogrammed functionality comprises providing a request for additional information from a user.

18. The website of claim 10, wherein the speech request comprises a set of text.

19. A method comprising:
in a set of code operating a web-site, generating a speech request;
sending the speech request to a speech output module, wherein the speech output module comprises code separate from set of code operating the web-site;
in a the set of code operating the web-site, generating a request for non-speech functionality; and
sending the request for non-speech functionality to the speech output module.

20. The method of claim 19, wherein the non-speech functionality comprises providing a request for additional information from a user.

21. The method of claim 19, wherein the speech request comprises a set of text.

22. A method comprising:
defining a speech playback module, the module comprising first code to accept speech requests from a user module and producing speech output;
defining second code which when executed provides second preprogrammed functionality separate from and augmenting the speech playback module, the second functionality not including speech functionality, the second functionality comprising functionality interacting with both a user and the speech playback module; and
creating an embedded code module comprising the first code and the second code.

23. The method of claim 22, wherein the speech output comprises an animated speaking figure and speech corresponding to the animated speaking figure.

24. A device comprising:
a first set of code operating a speech output module accepting speech requests and outputting speech audible to a user;
a second set of code associated with the first set of code and operating non-speech functionality;
a third set of code separate from the first set of code and from the second set of code and operating a web-site, the third set of code generating a speech request and sending the speech request to the first set of code;
the third set of code generating a request for non-speech functionality and sending the speech request to the third set of code; and
a processor to execute the code.

25. The device of claim 24, wherein the third set of code communicates with a remote web server for operating the web-site, and wherein the first set of code communicates with a remote speech server for providing text-to-speech functionality.
